(19) United States
(12) Patent Application Publication
(10) Pub. No.: US 2009/0317062 A1
(43) Pub. Date: Dec. 24, 2009

(54) IMAGE PROCESSING METHOD AND APPARATUS

(75) Inventors: Kil-soo JUNG, Osan-si (KR); Hyun-kwon CHUNG, Seoul (KR); Dae-jong LEE, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/490,572

(22) Filed: Jun. 24, 2009

Related U.S. Application Data
(60) Provisional application No. 61/075,184, filed on Jun. 24, 2008.

(30) Foreign Application Priority Data
Sep. 24, 2008 (KR) 10-2008-0093866

(51) Int. Cl. H04N 5/91

(52) U.S. Cl. 386/95; 386/E05.001

(57) ABSTRACT

An image processing method and apparatus to output video data, which is a two-dimensional (2D) image, as a three-dimensional (3D) image, the image processing method including: when a current frame of the video data is classified as a new shot that is different from a shot a previous frame of the video data that is output temporally before the current frame, estimating a motion of the current frame by using one or more next frames of the video data that are output temporally after the current frame and are classified as the new shot; and outputting the current frame as the 3D image by using the estimated motion.

### CROSS-REFERENCE TO RELATED APPLICATIONS

This application claims the benefit of U.S. Provisional Application No. 61/075,184, filed on Jun. 24, 2008 in the U.S. Patent and Trademark Office, and the benefit of Korean Patent Application No. 10-2008-0093866, filed on Sep. 24, 2008 in the Korean Intellectual Property Office, the disclosures of which are incorporated herein in their entirety by reference.

### BACKGROUND OF THE INVENTION

1. Field of the Invention

Aspects of the present invention generally relate to an image processing method and apparatus, and more particularly, to an image processing method and apparatus in which video data is output as a three-dimensional (3D) image by performing motion estimation on a current frame with reference to a next frame that is output temporally after (i.e., follows) the current frame.

2. Description of the Related Art

With the development of digital technology, three-dimensional (3D) image technology has widely spread. The 3D image technology expresses a more realistic image by adding depth information to a two-dimensional (2D) image. The 3D image technology can be classified into a technology to generate video data as a 3D image and a technology to convert video data generated as a 2D image into a 3D image. Both technologies have been studied together.

### SUMMARY OF THE INVENTION

Aspects of the present invention provide an image processing method and apparatus, in which a current frame is processed into a three-dimensional (3D) image by using a next frame following the current frame.

According to an aspect of the present invention, there is provided an image processing method to output video data, which is a two-dimensional (2D) image, as a three-dimensional (3D) image, the image processing method including: when a current frame of the video data is classified as a new shot that is different from a shot of a previous frame of the video data that is output temporally before the current frame, estimating a motion of the current frame by using one or more next frames of the video data that are output temporally after the current frame; and outputting the current frame as the 3D image by using the estimated motion, wherein the previous frame is temporally adjacent to the current frame and the video data includes a plurality of frames classified into units of predetermined shots.

According to an aspect of the present invention, the image processing method may further include: extracting, from metadata associated with the video data, shot information to classify the plurality of frames of the video data as the predetermined shots; and determining whether the current frame is classified as the new shot that is different from the shot of the previous frame by using the extracted shot information, wherein the shot information is used to classify, into a shot, a group of frames in which a motion of a frame is estimable by using another frame, of the group of frames.

According to an aspect of the present invention, the image processing method may further include, when the current frame is classified as the shot of the previous frame, estimating the motion of the current frame by using one or more previous frames, of the shot, that are output temporally before the current frame.

According to an aspect of the present invention, the determining of whether the current frame is classified as the new shot may include: extracting a shot start moment from the shot information; and when an output moment of the current frame is the same as the shot start moment, determining that the current frame is classified as the new shot that is different from the shot of the previous frame.

According to an aspect of the present invention, the image processing method may further include reading the metadata from a disc recorded with the video data or downloading the metadata from a server through a communication network.

According to an aspect of the present invention, the metadata may include identification information to identify the video data and the identification information may include a disc identifier (ID) to identify a disc recorded with the video data and a title ID to identify a title including the video data from among a plurality of titles recorded in the disc identified by the disc ID.

According to an aspect of the present invention, the estimating of the motion of the current frame may include: storing the one or more next frames, of the new shot, that are output temporally after the current frame; dividing the current frame into blocks of a predetermined size; selecting, for each of the blocks of the current frame, a corresponding block included in one of the one or more next frames; and obtaining a motion vector indicating a motion quantity and a motion direction for each of the blocks of the current frame by respectively using the corresponding block of the current frame and the selected block of the one next frame.

According to an aspect of the present invention, the image processing method may further include: synthesizing the corresponding block selected for each of the blocks of the current frame to generate a new frame; and generating a left-view image and a right-view image by using the current frame and the new frame.

According to another aspect of the present invention, there is provided an image processing apparatus to output video data, which is a two-dimensional (2D) image, as a three-dimensional (3D) image, the image processing apparatus including a motion estimating unit to estimate, when a current frame is classified as a new shot that is different from a shot of a previous frame that is output temporally before the current frame, a motion of the current frame by using one or more next frames that are output temporally after the current frame.

According to another aspect of the present invention, there is provided a method of transmitting metadata by a server connected to an image processing apparatus, the method including: receiving, by the server, a request for metadata used to convert video data, which is a two-dimensional (2D) image, into a three-dimensional (3D) image from the image processing apparatus; and transmitting, by the server, the metadata to the image processing apparatus in response to the request, wherein the metadata includes shot information to classify frames of the video data as predetermined shots and the shot information is used to classify a group of frames in which a motion of a current frame is estimable by using a previous frame that is output temporally before the current frame as a shot.

According to yet another aspect of the present invention, there is provided a server connected an image processing apparatus, the server including a transmitting/receiving unit to receive a request for metadata used to convert video data, which is a two-dimensional (2D) image, into a three-dimensional (3D) image from the image processing apparatus, and to transmit the metadata to the image processing apparatus in response to the request; and a metadata storing unit to store the metadata, wherein the metadata includes shot information to classify frames of the video data as predetermined shots and the shot information is used to classify a group of frames in which a motion of a current frame is estimable by using a previous frame that is output temporally before the current frame as a shot.

According to still another aspect of the present invention, there is provided a computer-readable recording medium having recorded thereon a program to execute an image processing method to output video data, which is a two-dimensional (2D) image, as a three-dimensional (3D) image, and implemented by an image processing apparatus, the image processing method including, when a current frame is classified as a new shot that is different from a shot of one or more previous frames that are output temporally before the current frame, estimating a motion of the current frame by using a next frame that is output temporally after the current frame, and outputting the current frame as the 3D image by using the estimated motion.

According to another aspect of the present invention, there is provided a computer-readable recording medium implemented by an image processing apparatus, the computer-readable recording medium including: metadata associated with video data including a plurality of frames, the metadata used by the image processing apparatus to convert the video data from a two-dimensional image to a three-dimensional image, wherein the metadata comprises shot information to classify, into a shot, a group of frames of the plurality of frames in which a motion of a frame, from among the group of frames, is estimable by using another frame, of the group of frames, and the shot information is used by the image processing apparatus to convert the frame of the shot from the 2D image to the 3D image by estimating the motion of the frame by using the another frame of the shot.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates metadata according to an embodiment of the present invention;

FIG. 2 is a block diagram of an image processing system to execute an image processing method according to an embodiment of the present invention;

FIG. 3 is a block diagram of an image processing apparatus according to an embodiment of the present invention;

FIG. 4 is a view to explain an operation in which a metadata analyzing unit of the image processing apparatus illustrated in FIG. 3 controls a switching unit to control output operations of a previous frame storing unit and a next frame storing unit; and

FIG. 5 is a flowchart illustrating an image processing method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

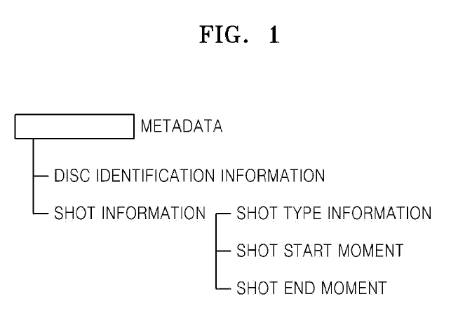

FIG. 1 illustrates metadata according to an embodiment of the present invention. The metadata includes information to convert video data, which is a two-dimensional (2D) image, into a three-dimensional (3D) image. In order to identify the video data that the metadata is associated with, the metadata includes disc identification information to identify a disc (such as a DVD, a Blu-ray disc, etc.) recorded with the video data. The disc identification information may include a disc identifier (ID) to identify the disc recorded with the video data and/or a title ID to identify a title including the video data from among a plurality of titles recorded in the disc identified by the disc ID. However, it is understood that the metadata need not include the disc identification information in all aspects. For example, when the video data is recorded in a storage medium other than a disc (such as an external terminal, a server, a flash memory, a local storage, an external storage device, etc.), the metadata may not include the disc identification information, or instead might include an address to the external terminal.

Since the video data includes a series of frames, the metadata includes information about the frames. The information about the frames includes information to classify the frames according to a predetermined criterion. Assuming that a group of similar frames is a unit, all of the frames of the video data can be classified as a plurality of units. In aspects of the present invention, information to classify all of the frames of the video data as predetermined units is included in the metadata. Specifically, in aspects of the present invention, a group of frames in which a motion of a current frame can be estimated with reference to a previous frame that is output temporally before (i.e., precedes) the current frame is referred to as a shot. When the motion of the current frame cannot be estimated by using the previous frame due to a low similarity between those frames, the current frame and the previous frame are classified as different shots.

The metadata includes information to classify frames of video data as shots. Information about a shot (i.e., shot information) includes information about output moments of frames classified as the shot (for example, a shot start moment and a shot end moment). The shot start moment indicates an output moment of a frame that is temporally output first from among frames classified as a shot and the shot end moment indicates an output moment of a frame that is temporally output last from among frames classified as a shot. However, it is understood that aspects of the present invention are not limited to the shot information including the shot start moment and the shot end moment. For example, according to other aspects, the shot information may additionally or alternatively include a number of frames in a shot, or a duration of time for reproducing all of the frames in a shot relative to a start or stop frame or moment.

While not required in all aspects, the shown shot information further includes shot type information about frames classified as a shot. The shot type information indicates for each shot whether frames classified as the shot are to be output as a 2D image or a 3D image. As such, according to the embodiment of the present invention, the metadata to convert video data into a 3D image includes the shot information to classify frames of the video data as shots.

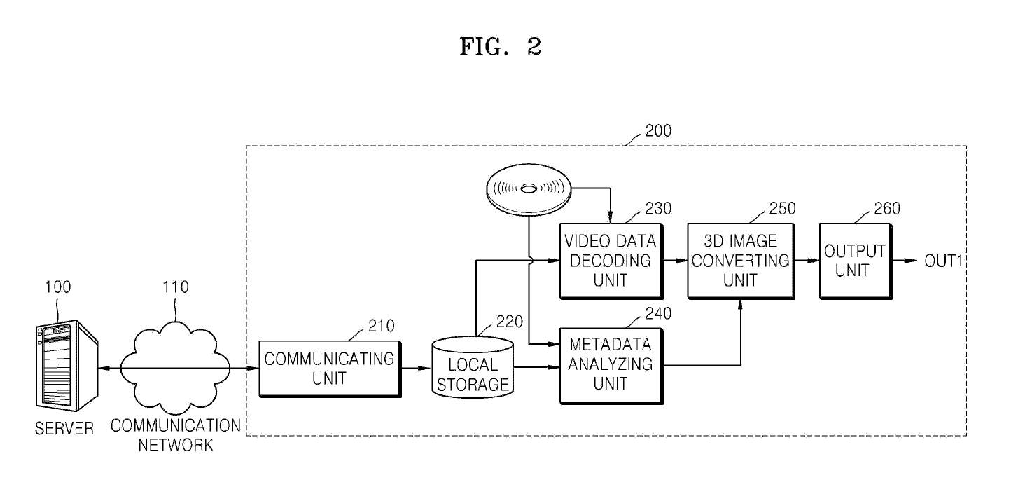

FIG. 2 is a block diagram of an image processing system to execute an image processing method according to an embodiment of the present invention. Referring to FIG. 2, the image processing system includes a server 100, a communication network 110, and an image processing apparatus 200. The server 100 may be operated by a broadcasting station or a contents provider such as a common contents creation company. The server 100 stores therein, as contents, audio/video (AV) streams such as video data and audio data and/or metadata associated with AV streams. The server 100 extracts contents requested by a user and provides the extracted contents to the user. The communication network 110 may be a wired or wireless communication network, such as the Internet or a broadcasting network.

The image processing apparatus 200 transmits and/or receives information to/from the server 100 through the communication network 110, though it is understood that aspects of the present invention are not limited thereto. That is, according to other aspects, the image processing apparatus 200 does not transmit or receive information to/from the server 100, but receives information from an external terminal, an external storage device, a local storage device, and/or a server that is directly connected (wired and/or wirelessly) to the image processing apparatus 200. The image processing apparatus 200 includes a communicating unit 210, a local storage 220, a video data decoding unit 230, a metadata analyzing unit 240, a 3D image converting unit 250, and an output unit 260 to output a 3D image generated in a 3D format to a screen (not shown). However, in other embodiments, the image processing apparatus 200 does not include the output unit 260, and/or the image processing apparatus transmits the 3D image to an external device or an external output unit.

Through the communication network 110, the communicating unit 210 requests user-desired contents from the server 100 and receives the contents from the server 100. For wireless communication, the communicating unit 210 may include a wireless signal transmitting/receiving unit (not shown), a baseband processing unit (not shown), and/or a link control unit (not shown). For wireless communication, wireless local area network (WLAN), Bluetooth, Zigbee, and/or wireless and broadband Internet (WiBro) technologies may be used.

The local storage 220 stores information that is downloaded from the server 100 by the communicating unit 210. In the present embodiment, the local storage 220 stores contents transmitted from the server 100 through the communicating unit 210 (i.e., video data, audio data, and/or metadata associated with the video data or the audio data). However, it is understood that in other embodiments, the video data, the audio data, and/or the metadata associated with the video data or the audio data may be stored in the server 100, an external terminal, an external storage device, a disc, etc. in a multiplexed state or separately from each other.

When video data and/or metadata associated with the video data are stored in a disc in a multiplexed state or separately from each other, upon loading of the disc recorded with the video data and/or the metadata into the image processing apparatus 200, the video data decoding unit 230 and the metadata analyzing unit 240 read the video data and the metadata from the loaded disc, respectively. The metadata may be stored in a lead-in region, a user data region, and/or a lead-out region of the disc. In particular, when the video data is recorded in the disc, the metadata analyzing unit 240 extracts, from the metadata, a disc ID to identify the disc recorded with the video data and a title ID to identify a title including the video data from among a plurality of titles recorded in the disc identified by the disc ID. Accordingly, the metadata analyzing unit 240 determines with which video data the metadata is associated by using the extracted disc ID and title ID. While described as being stored on the disc, it is understood that the metadata could be retrieved from the server 100 and need not be stored on the disc with the video data. Furthermore, while the image processing apparatus 200 is shown as capable of receiving both the disc and AV data over the communication network 110, it is understood that the apparatus 200 need not be capable of receiving both the disc and the AV streams in all aspects. Also, while not required, the image processing apparatus 200 can include a drive to read the disc directly, or can be connected to a separate drive.

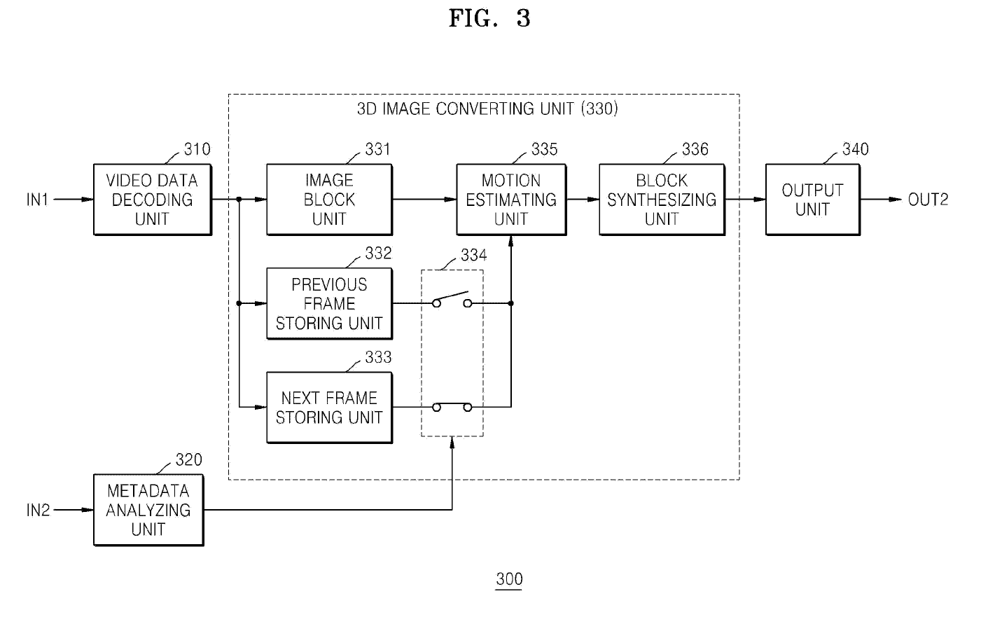

The video data decoding unit 230 and the metadata analyzing unit 240 read the video data and the metadata, respectively, from the local storage, the disc, etc., for decoding. The metadata analyzing unit 240 determines whether to output frames, which are classified as a predetermined shot, as a 2D image or a 3D image by using shot type information included in the metadata, and controls the 3D image converting unit 250 according to a result of the determination. Under the control of the metadata analyzing unit 240, the 3D image converting unit 250 outputs the video data to the output unit 260 as a 2D image or converts the video data into a 3D image by using a previous frame that is output temporally before (i.e., precedes) a current frame or a next frame that is output temporally after (i.e., follows) the current frame. The conversion of the video data from a 2D image into a 3D image, performed by the 3D image converting unit 250, will be described in more detail with reference to FIG. 3. The output unit 260 outputs the video data converted into the 3D image to a screen (not shown).

FIG. 3 is a block diagram of an image processing apparatus 300 according to an embodiment of the present invention. Referring to FIG. 3, the image processing apparatus 300 includes a video data decoding unit 310, a metadata analyzing unit 320, a 3D image converting unit 330, and an output unit 340. When video data, which is a 2D image, and metadata associated with the video data are recorded in a multiplexed state or separately from each other in a disc, upon loading of the disc recorded with the video data and the metadata into the image processing apparatus 300, the video data decoding unit 310 and the metadata analyzing unit 320 read the video data and the metadata from the loaded disc, respectively. The metadata may be stored in a lead-in region, a user data region, and/or a lead-out region of the disc.

Although not shown in FIG. 3, the image processing apparatus 300 may further include a communicating unit to receive information from a server and/or a database and a local storage to store information received through the communicating unit, as in FIG. 2. The image processing apparatus 300 may download video data and/or metadata associated with the video data from an external server or an external terminal through a communication network and store the downloaded video data and/or metadata in the local storage (not shown). Alternatively, the apparatus 300 could read the video data from the disc, and the associated meta data from the server. Furthermore, the image processing apparatus 300 may receive the video data and/or the metadata associated with the video data from an external storage device different from the disc, such as a flash memory or an external hard disk drive.

The video data decoding unit 310 reads the video data from the disc or the local storage and decodes the read video data. As stated previously, the video data decoded by the video data decoding unit 310 may be classified as predetermined shots according to the similarity between frames.

The metadata analyzing unit 320 reads the metadata associated with the video data from the disc or the local storage and analyzes the read metadata. When the video data is recorded in the disc, the metadata analyzing unit 320 extracts, from the metadata, a disc ID to identify the disc recorded with the video data and a title ID to identify a title including the video data from among a plurality of titles recorded in the disc identified by the disc ID. Accordingly, the metadata analyzing unit 320 determines with which video data the metadata is associated by using the extracted disc ID and title ID. Also, while not required, the image processing apparatus 300 can include a drive to read the disc directly, or can be connected to a separate drive.

The 3D image converting unit 330 includes an image block unit 331, a previous frame storing unit 332, a next frame storing unit 333, a switching unit 334, a motion estimating unit 335, and a block synthesizing unit 336. The image block unit 331 divides a frame of video data, which is a 2D image, into blocks of a predetermined size. The previous frame storing unit 332 and the next frame storing unit 333 store a predetermined number of previous frames preceding a current frame and a predetermined number of next frames following the current frame, respectively. While not required, each of the units 310, 320, 331, 335, 336, 340 can be a processor or processing elements on one or more chips or integrated circuits.

The motion estimating unit 335 estimates a motion of the current frame by using a previous frame preceding the current frame or a next frame following the current frame. To convert the current frame, which is a 2D image, into a 3D image, motion information of the current frame is extracted with reference to one or more previous frames. However, if the current frame is classified as a new shot, it is not possible to obtain the motion information of the current frame by using previous frames. Therefore, in aspects of the present invention, if the current frame is classified as a new shot, the motion estimating unit 335 estimates a motion of the current frame by using one or more next frames following the current frame. The switching unit 334 causes the motion estimating unit 335 to refer to one or more previous frames stored in the previous frame storing unit 332 or one or more next frames stored in the next frame storing unit 333 under the control of the metadata analyzing unit 320.

The metadata analyzing unit 320 extracts shot information from the metadata. As stated above, the shot information includes shot type information, a shot start moment indicating an output moment of a frame that is temporally output first from among frames classified as a shot, and a shot end moment indicating an output moment of a frame that is temporally output last from among frames classified as a shot. The metadata analyzing unit 320 determines whether to output frames, which are classified as a predetermined shot, as a 2D image or a 3D image by using the shot type information.

If the metadata analyzing unit 320 determines to output a frame, which is classified as a predetermined shot, as a 2D image, it controls the switching unit 334 to cause the motion estimating unit 335 to not refer to previous frames stored in the previous frame storing unit 332 or next frames stored in the next frame storing unit 333. Conversely, the metadata analyzing unit 320, when determining to output the frame as a 3D image, controls the switching unit 334 to cause the motion estimating unit 335 to estimate a motion of the current frame by referring to the previous frames or the next frames. In some aspects, the motion estimating unit 335 may estimate the motion of the current frame by referring to both previous frames and next frames.

The metadata analyzing unit 320 determines whether an output moment of the current frame is the shot start moment based on the shot information. If the output moment of the current frame is the shot start moment, the metadata analyzing unit 320 determines that the current frame is classified as a new shot. Accordingly, a motion of the current frame classified as the new shot cannot be estimated by referring to one or more frames classified as a previous shot. The metadata analyzing unit 320, when determining that the current frame is classified as the new shot, controls the switching unit 334 to cause the motion estimating unit 335 to estimate the motion of the current frame by referring to one or more next frames stored in the next frame storing unit 333, instead of one or more previous frames stored in the previous frame storing unit 332 which is disconnected by the switching unit 334.

When the metadata analyzing unit 320 determines that the current frame is not classified as a new shot, it controls the switching unit 334 to cause the motion estimating unit 335 to estimate the motion of the current frame by referring to one or more previous frames stored in the previous frame storing unit 332, instead of one or more next frames stored in the next frame storing unit 333.

When the current frame is classified as a new shot that is different from that of a previous frame, the motion estimating unit 335, for each of blocks obtained by dividing the current frame in the image block unit 331, selects a block that is most similar to the block of the current frame from among blocks of one of a predetermined number of next frames stored in the next frame storing unit 333. The motion estimating unit 335 obtains, for each of the blocks of the current frame, a motion vector indicating a motion direction and a motion quantity by using the block of the current frame and the selected block of the next frame.

The block synthesizing unit 336 synthesizes selected blocks to generate a new frame using the motion vector and outputs the generated new frame as a 3D video image to the output unit 340. The output unit 340 determines one of the new frame and the current frame as a left-view image and the other frame as a right-view image, or generates a left-view image and a right-view image by using the new frame and the current frame. The output unit 340 outputs the left-view image and the right-view image to a screen (not shown).

When a frame classified as a predetermined shot is to be output as a 2D image (i.e., when the shot type information indicates that the frame classified as the predetermined shot is to be output as a 2D image), the motion estimating unit 335 outputs a 2D image received from the image block unit 331 to the block synthesizing unit 336 without estimating a motion of the current frame with reference to previous or next frames, and the block synthesizing unit 336 outputs the received 2D image to the output unit 340. The output unit 340 then outputs the same 2D image as a left-view image and a right-view image to the screen (not shown).

As such, according to the shown embodiment of the present invention, metadata is used to determine whether a current frame is classified as a new shot. Accordingly, if the current frame is classified as a new shot, a motion of the current frame is estimated by using one or more next frames following the current frame instead of one or more previous frames preceding the current frame and the current frame is output as a 3D image by using the estimated motion.

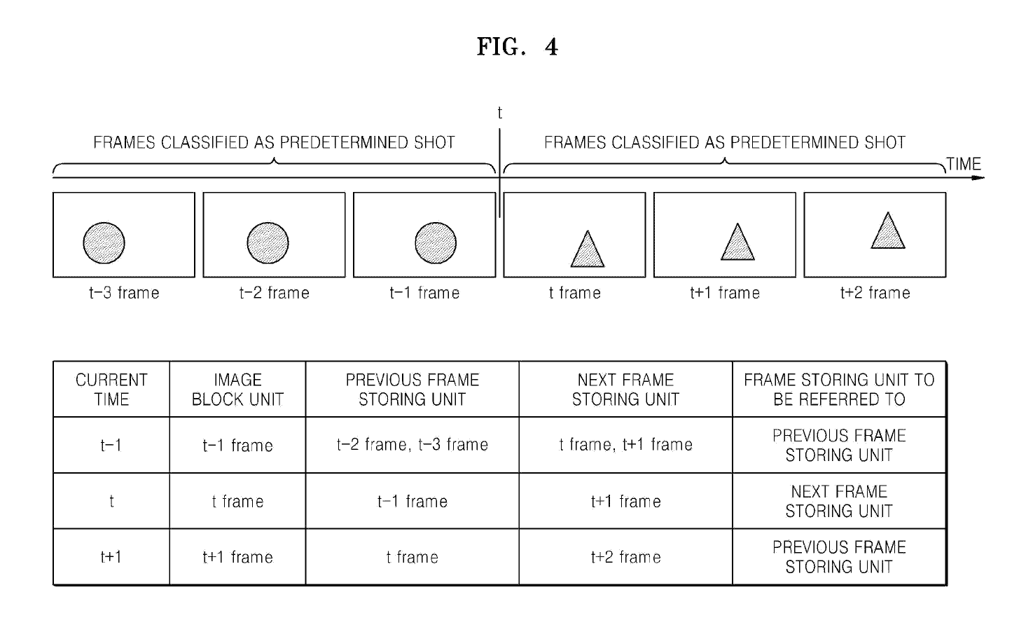

FIG. 4 is a view to explain an operation in which the metadata analyzing unit 320 of the image processing apparatus 300 controls the switching unit 334 to control output operations of the previous frame storing unit 332 and the next frame storing unit 333. Referring to FIG. 4, video data, which is a 2D image, includes a plurality of frames. Since frames being output prior to (t−1) or at (t−1) and frames being output after t have no similarity therebetween, the frames being output prior to (t−1) or at (t−1) and the frames being output after t are classified as different shots. As shown, the first shot extends from the (t−3) frame to the (t−1) frame, and the second shot extents from the t frame to the (t+2) frame.

The metadata analyzing unit 320 reads a shot start moment and/or a shot end moment by using the shot information included in the metadata. In FIG. 4, it is assumed that the first shot end moment is (t−1) and the second shot start moment is t. When the current time is (t−1), the image block unit 331 divides a current frame being output at (t−1) (i.e. a (t−1) frame in FIG. 4) into blocks of a predetermined size. The previous frame storing unit 332 stores frames being output prior to (t−1) (i.e., the (t−3) and (t−2) frames) and the next frame storing unit 333 stores frames being output after (t−1). Each of the previous frame storing unit 332 and the next frame storing unit 333 may store at least one frame. The metadata analyzing unit 320 determines that a next frame following the current frame is classified as a new shot because the output moment of the current frame is the same as the shot end moment. The metadata analyzing unit 320 controls the switching unit 334 to cause the motion estimating unit 335 to refer to one or more previous frames stored in the previous frame storing unit 332 instead of one or more next frames stored in the next frame storing unit 333. The motion estimating unit 335 selects a corresponding block, for each block obtained by dividing the frame being output at (t−1), that is most similar to the block of the (t−1) frame from among blocks of a previous frame stored in the previous frame storing unit 332. Accordingly, the motion estimating unit 335 estimates a motion of each of the blocks of the (t−1) frame by respectively using the blocks of the (t−1) frame and the selected blocks of the previous (t−2) and (t−2) frames.

When the current time is t, the image block unit 331 divides a current frame being output at t (a t frame in FIG. 4) into blocks of a predetermined size. The previous frame storing unit 332 stores frames being output prior to (t) and the next frame storing unit 333 stores frames being output after (t). Since the output moment of a current frame is t, the metadata analyzing unit 320 determines that the current frame is classified as a new shot and controls the switching unit 334 to cause the motion estimating unit 335 to refer to one or more next (t+1_ and (t+2) frames stored in the next frame storing unit 333 instead of one or more previous (t−1) and (t−2) frames stored in the previous frame storing unit 332. The motion estimating unit 335 selects a corresponding block, for each block obtained by dividing the frame being output at t, that is most similar to the block of the t frame from among blocks of one of next frames stored in the next frame storing unit 333. Accordingly, the motion estimating unit 335 estimates a motion of each of the block of the t frame by respectively using the blocks of the t frame and the selected blocks of the next frame. In other words, the motion estimating unit 335 estimates a motion from the previous frame to the current frame by referring to the current frame and one or more next frames following the current frame.

When the current time is (t+1), the image block unit 331 divides a current frame being output at (t+1) (i.e. a (t+1) frame in FIG. 4) into blocks of a predetermined size. Since the current frame is not classified as a new shot, the metadata analyzing unit 320 controls the switching unit 334 to cause the motion estimating unit 335 to refer to one or more previous frames stored in the previous frame storing unit 332 instead of one or more next frames stored in the next frame storing unit 333. The motion estimating unit 335 selects a corresponding block, for each block obtained by dividing the frame being output at (t+1), that is most similar to the block of the (t+1) frame from among blocks of one of previous frames stored in the one or more previous frames storing unit 332. Accordingly, the motion estimating unit 335 estimates a motion of each of the blocks of the (t+1) frame by respectively using the blocks of the (t+1) frame and the selected blocks of the previous frames.

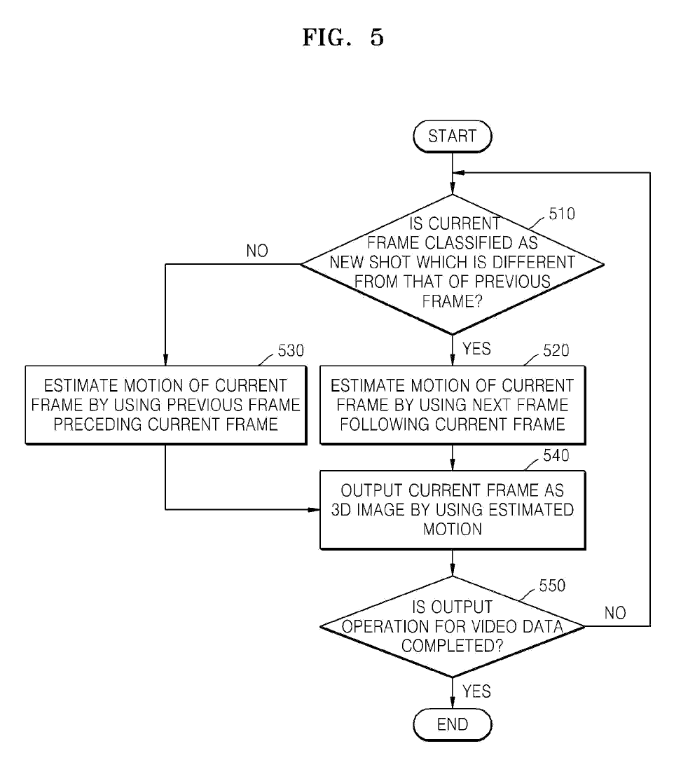

FIG. 5 is a flowchart illustrating an image processing method according to an embodiment of the present invention. Upon loading of a disc (not shown), the image processing apparatus 300, when instructed to reproduce predetermined video data recorded in the loaded disc, determines whether metadata associated with the predetermined video data exists in the loaded disc or a local storage (not shown) of the image processing apparatus 300 by using a disc ID and a title ID. If the metadata associated with the video data does not exist in the loaded disc or the local storage, the image processing apparatus 300 may download the metadata associated with the video data from an external server through a communication network. However, it is understood that aspects of the present invention are not limited thereto. For example, according to other aspects the video data and/or the meta data may be read or received from an external terminal, an external server directly connected to the image processing apparatus 300, an external storage device different from the disc, etc.

Referring to FIG. 5, the image processing apparatus 300 determines whether a current frame to be output is classified as a new shot that is different from that of a previous frame in operation 510. If the current frame is classified as the new shot (operation 510), the image processing apparatus 300 estimates a motion of the current frame by using one or more frames being output temporally after the current frame in operation 520. If the current frame is classified as the same shot as that of a previous frame (operation 510), the image processing apparatus 300 estimates a motion of the current frame by using one or more previous frames in operation 530. The image processing apparatus 300 outputs the current frame as a 3D image by using the estimated motion in operation 540. Furthermore, the image processing apparatus 300 determines whether an output operation for the video data is completed in operation 550. If the video data is not entirely output (operation 550), the image processing apparatus 300 returns to operation 510 in order to determine whether the current frame is classified as the same shot as that of a previous frame.

As is apparent from the foregoing description, according to aspects of the present invention, when a current frame is classified as a new shot, a motion of the current frame can be estimated by referring to one or more next frames following the current frame. In this case, it is possible to reduce unnecessary computation used to estimate the motion of the current frame by referring to one or more previous frames having no similarity with the current frame classified as a new shot. Moreover, when the current frame is classified as a new shot, the motion of the current frame is estimated by referring to one or more next frames following the current frame, thereby more accurately estimating the motion of the current frame.

While not restricted thereto, aspects of the present invention can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet. Moreover, while not required in all aspects, one or more units of the image processing apparatus 200 or 300 can include a processor or microprocessor executing a computer program stored in a computer-readable medium, such as the local storage 220.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image processing method of an image processing apparatus to output video data comprising a two-dimensional (2D) images as three-dimensional (3D) video images, the image processing method comprising:
when a current frame of the video data is classified as a new shot that is different from a shot of a previous frame of the video data that is output temporally before the current frame, estimating, by the image processing apparatus, a motion of the current frame by using one or more next frames of the video data that are output temporally after the current frame and are classified as the new shot; and
outputting, by the image processing apparatus, the current frame as the 3D video images by using the estimated motion,
wherein the previous frame is temporally adjacent to the current frame and the video data includes a plurality of frames classified into units of predetermined shots.

2. The image processing method as claimed in claim 1, further comprising:
extracting, from metadata associated with the video data, shot information to classify the plurality of frames of the video data as the predetermined shots; and
determining whether the current frame is classified as the new shot that is different from the shot of the previous frame by using the extracted shot information,
wherein the shot information is used to classify, into a shot, a group of frames in which a motion of a frame, from among the group of frames, is estimable by using another frame, of the group of frames.

3. The image processing method as claimed in claim 1, further comprising:
when the current frame is classified as the shot of the previous frame, estimating the motion of the current frame by using one or more previous frames, of the shot, that are output temporally before the current frame.

4. The image processing method as claimed in claim 2, wherein the determining of whether the current frame is classified as the new shot comprises:
extracting a shot start moment from the shot information; and
when an output moment of the current frame is the same as the shot start moment, determining that the current frame is classified as the new shot that is different from the shot of the previous frame.

5. The image processing method as claimed in claim 2, further comprising:
reading the metadata from a disc recorded with the video data or downloading the metadata from a server through a communication network.

6. The image processing method as claimed in claim 2, wherein:
the metadata comprises identification information to identify the video data; and
the identification information comprises a disc identifier (ID) to identify a disc recorded with the video data and a title ID to identify a title including the video data from among a plurality of titles recorded in the disc identified by the disc ID.

7. The image processing method as claimed in claim 1, wherein the estimating of the motion of the current frame comprises:
storing the one or more next frames, of the new shot, that are output temporally after the current frame;
dividing the current frame into blocks of a predetermined size;
for each of the blocks of the current frame, selecting a corresponding block included in one of the one or more next frames; and
obtaining a motion vector indicating a motion quantity and a motion direction for each of the blocks of the current frame by respectively using the corresponding block of the current frame and the selected block of the one next frame.

8. The image processing method as claimed in claim 7, wherein the selecting of the corresponding block comprises:
for each of the blocks of the current frame, selecting one block that is most similar to the current frame from among divided blocks of the one or more next frames.

9. The image processing method as claimed in claim 7, further comprising:
synthesizing the corresponding block selected for each of the blocks of the current frame to generate a new frame; and
generating a left-view image and a right-view image by using the current frame and the new frame.

10. An image processing apparatus to output video data comprising two-dimensional (2D) images as three-dimensional (3D) video images, the image processing apparatus comprising:
a motion estimating unit to estimate, when a current frame of the video data is classified as a new shot that is different from a shot of a previous frame of the video data that is output temporally before the current frame, a motion of the current frame by using one or more next frames of the video data that are output temporally after the current frame and are classified as the new shot; and
a block synthesizing unit to create the 3D video image using the current frame and the estimated motion, wherein the previous frame is temporally adjacent to the current frame and the video data includes a plurality of frames classified into units of predetermined shots.

11. The image processing apparatus as claimed in claim 10, further comprising:
a metadata analyzing unit to extract, from metadata associated with the video data, shot information to classify the plurality of frames of the video data as the predetermined shots, and to determine whether the current frame is classified as the new shot that is different from the shot of the previous frame by using the extracted shot information,
wherein the shot information is used to classify, into a shot, a group of frames in which a motion of a frame, from among the group of frames, is estimable by using another frame, of the group of frames.

12. The image processing apparatus as claimed in claim 10, wherein when the current frame is classified as the shot of the previous frame, the motion estimating unit estimates the motion of the current frame by using one or more previous frames, of the shot, that are output temporally before the current frame.

13. The image processing apparatus as claimed in claim 11, wherein the metadata analyzing unit extracts a shot start moment from the shot information and, when an output moment of the current frame is the same as the shot start moment, determines that the current frame is classified as the new shot that is different from the shot of the previous frame.

14. The image processing apparatus as claimed in claim 11, wherein the metadata analyzing unit reads the metadata from a disc recorded with the video data or downloads the metadata from a server through a communication network.

15. The image processing apparatus as claimed in claim 11, wherein:
the metadata comprises identification information to identify the video data; and
the identification information comprises a disc identifier (ID) to identify a disc recorded with the video data and a title ID to identify a title including the video data from among a plurality of titles recorded in the disc identified by the disc ID.

16. The image processing apparatus as claimed in claim 10, further comprising:
a next frame storing unit to store the one or more next frames, of the new shot, that are output temporally after the current frame; and
an image block unit to divide the current frame into blocks of a predetermined size,
wherein the motion estimating unit, for each of the blocks of the current frame, selects a corresponding block included in one of the one or more next frames, and obtains a motion vector indicating a motion quantity and a motion direction for each of the blocks of the current frame by respectively using the corresponding block of the current frame and the selected block of the one next frame.

17. The image processing apparatus as claimed in claim 16, wherein the motion estimating unit selects one block that is most similar to the block of the current frame from among divided blocks of the one or more next frames.

18. The image processing apparatus as claimed in claim 16, further comprising:
an output unit to generate a left-view image and a right-view image,
wherein the block synthesizing unit synthesizes the corresponding block selected for each of the blocks of the current frame to generate a new frame using the motion vector, and the output unit generates the left-view image and the right-view image by using the current frame and the new frame.

19. A method of transmitting metadata by a server connected to an image processing apparatus, the method comprising:
receiving, by the server, a request for metadata used to convert video data comprising two-dimensional (2D) images into three-dimensional (3D) video images from the image processing apparatus; and
transmitting the metadata from the server to the image processing apparatus in response to the request,
wherein the metadata comprises shot information to classify frames of the video data as predetermined shots and the shot information is used to classify, into a shot, a group of frames of the video data in which a motion of a frame, from among the group of frames, is estimable by using another frame, of the group of frames, that is output temporally before the current frame.

20. A server which connected to an image processing apparatus, the server comprising:
a transmitting/receiving unit to receive a request for metadata used to convert video data comprising two-dimensional (2D) images into three-dimensional (3D) video images from the image processing apparatus, and to transmit the metadata to the image processing apparatus in response to the request; and
a metadata storing unit storing the metadata,
wherein the metadata comprises shot information to classify frames of the video data as predetermined shots and the shot information is used to classify, into a shot, a group of frames of the video data in which a motion of a frame, from among the group of frames, is estimable by using another frame, of the group of frames, that is output temporally before the current frame.

21. A computer-readable recording medium having recorded thereon a program to execute the image processing method of claim 1 and implemented by the image processing apparatus.

22. A computer-readable recording medium implemented by an image processing apparatus, the computer-readable recording medium comprising:
metadata associated with video data including a plurality of frames, the metadata used by the image processing apparatus to convert the video data from a two-dimensional (2D) image to a three-dimensional (3D) image,
wherein the metadata comprises shot information used by the image processing apparatus to classify, into a shot, a group of frames of the plurality of frames in which a motion of a frame in the shot is estimable by using another frame in the shot, and
the shot information being used by the image processing apparatus to convert the frame of the shot from the 2D image to the 3D image by estimating the motion of the frame by using the another frame of the shot.

23. The computer-readable recording medium as claimed in claim 22, wherein the shot information indicates to the image processing apparatus whether a current frame of the video data is classified as a new shot that is different from a shot of a previous frame of the video data that is output temporally before the current frame, such that the image processing apparatus only uses a next frame temporally after the current frame to convert the current frame when the current frame is classified as the new shot and uses the previous frame to convert the current frame when the current frame is not classified as the new shot.
